(19) United States
(12) Patent Application Publication
(10) Pub. No.: US 2010/0236925 A1
(43) Pub. Date: Sep. 23, 2010

(54) CERAMIC STRUCTURE AND GAS SENSOR INCLUDING THE CERAMIC STRUCTURE

(75) Inventors: Akira UCHIKAWA, Midori-shi (JP); Masami Kawashima, Oura-gun (JP); Shoichi Sakai, Midori-shi (JP); Masao Tsukada, Isesaki-shi (JP); Keiji Mori, Isesaki-shi (JP); Kousaku Morita, Yokohama-shi (JP)

Correspondence Address: FOLEY AND LARDNER LLP;SUITE 500, 3000 K STREET NW, WASHINGTON, DC, 20007, US

(73) Assignee: HITACHI AUTOMOTIVE SYSTEMS, LTD.

(21) Appl. No.: 12/720,485

(22) Filed: Mar. 9, 2010

(30) Foreign Application Priority Data
Mar. 17, 2009 (JP) 2009-064720

(51) Int. Cl. G01N 27/26; B32B 5/22

(52) U.S. Cl. 204/424; 428/317.9

(57) ABSTRACT

A gas sensor includes a ceramic structural member. The ceramic structural member includes a base body formed of an insulating material; and a porous ceramic layer formed integrally with the base body. The ceramic layer is formed of an admixture obtained by mixing a plurality of ceramic materials with each other. The plurality of ceramic materials have grain size distributions different from each other.

### BACKGROUND OF THE INVENTION

The present invention relates to a ceramic structure and/or a gas sensor including the same.

As a gas sensor, there is an oxygen sensor for detecting a concentration of oxygen included in exhaust gas in order to control an internal combustion engine of vehicle.

Japanese Patent Application Publication No. 2005-351740 discloses a previously proposed gas sensor. The gas sensor disclosed in this application includes a sensing element for detecting the oxygen concentration of exhaust gas. This sensing element detects the oxygen concentration by passing a gas through a porous layer provided between a base body formed of a ceramic material and a reference electrode for sensing the oxygen concentration.

### SUMMARY OF THE INVENTION

In such a sensing element, it is preferred that a porosity of the porous layer is made high in order to easily pass the gas between the reference electrode and the base body. However, if the porosity of the porous layer is set high, a strength of the porous layer is reduced.

It has been difficult to secure the strength of porous layer in earlier technologies.

It is therefore an object of the present invention to provide a ceramic structure and/or a gas sensor including the ceramic structure, capable of improving a function of ceramic layer.

According to one aspect of the present invention, there is provided a gas sensor including a ceramic structural member, the ceramic structural member comprising: a base body formed of an insulating material; and a porous ceramic layer formed integrally with the base body, wherein the ceramic layer is formed of an admixture of a plurality of ceramic materials, the plurality of ceramic materials having grain size distributions different from each other.

According to another aspect of the present invention, there is provided a gas sensor comprising: a sensing element configured to sense a gas component; a holder formed with an insertion hole, the sensing element being fitted into the insertion hole by insertion; a seal portion sealing between the holder and an outer circumference of the sensing element by filling a sealant storage space with a compressed sealant, the sealant storage space being provided on an outer circumference of the insertion hole of the holder; and a porous ceramic layer provided in a surface of at least a portion of the sensing element, the portion receiving a load caused by the filling of the sealant, the porous ceramic layer being formed of an admixture of a plurality of ceramic materials having at least one of grain diameters different from each other and specific surface areas different from each other.

The other objects and features of this invention will become understood from the following description with reference to the accompanying drawings.

### BRIEF DESCRIPTION OF DRAWINGS

FIG. 1 is a side view showing a state where an oxygen sensor in an embodiment according to the present invention has been attached to an exhaust pipe.

FIG. 2 is a cross-sectional view of the oxygen sensor (cross-sectional view taken along an axial direction of the oxygen sensor) in the embodiment.

FIG. 3 is an enlarged cross-sectional view (cross-sectional view taken along the axial direction) showing a main portion of a sensing element in the embodiment.

FIG. 4A is a side view of the sensing element.

FIG. 4B is a cross-sectional view of FIG. 4A, taken along a line A-A.

FIG. 5 is an exploded view of the sensing element into respective layers.

FIG. 6 is a graph showing a grain size distribution of a ceramic material which forms an air-pass layer (ceramic layer) of the sensing element.

FIG. 7 is a schematic view showing a structure of the air-pass layer according to the present invention and a structure of air-pass layer in a comparative technology.

FIG. 8 is a characteristic view showing a relation between a breaking strength of the air-pass layer and a mixture ratio between one ceramic material having a small grain diameter and another ceramic material having a large grain diameter.

FIG. 9 is a characteristic view showing a relation between a coating thickness of the air-pass layer and a generation rate of crack in a solid electrolyte layer in a case that the another ceramic material having the large grain diameter is mixed, and in a case that the another ceramic material is not mixed.

FIG. 10 is a characteristic view showing a relation between the breaking strength of air-pass layer and the mixture ratio between the one ceramic material having the small grain diameter and the another ceramic material having the large grain diameter, in a case that a carbon concentration at which the carbon is mixed into the ceramic materials is varied.

FIG. 11 is a characteristic view showing a relation between the breaking strength of air-pass layer and the carbon concentration, in a case that the mixture ratio of the one ceramic material having the small grain diameter and the another ceramic material having the large grain diameter is varied.

### DETAILED DESCRIPTION OF THE INVENTION

Hereinafter, embodiments according to the present invention will be explained in detail with reference to the drawings. In the following embodiments, an oxygen sensor for detecting air-fuel ratio, which is provided to an exhaust pipe of a vehicle such as an automotive vehicle or two-wheeled vehicle equipped with an internal combustion engine, will be described as one example.

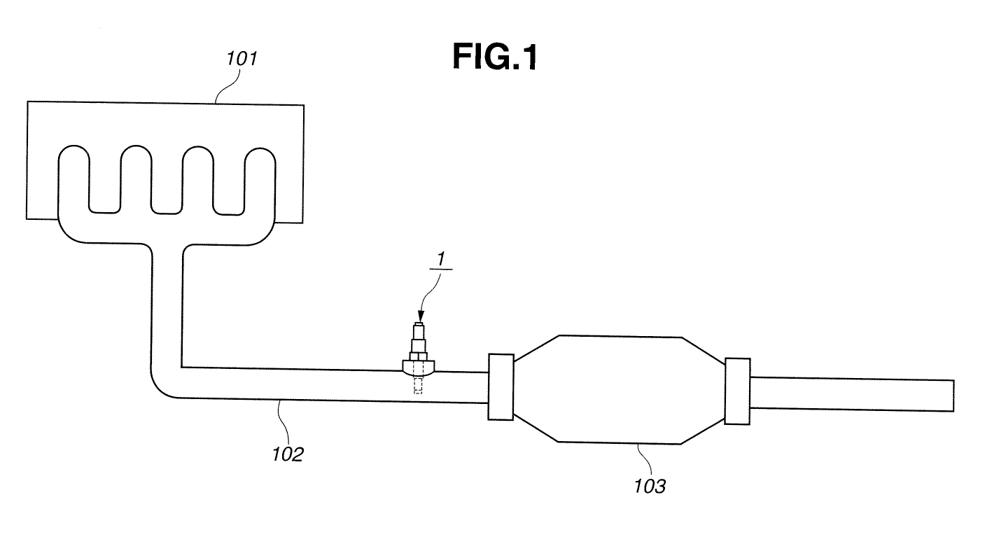

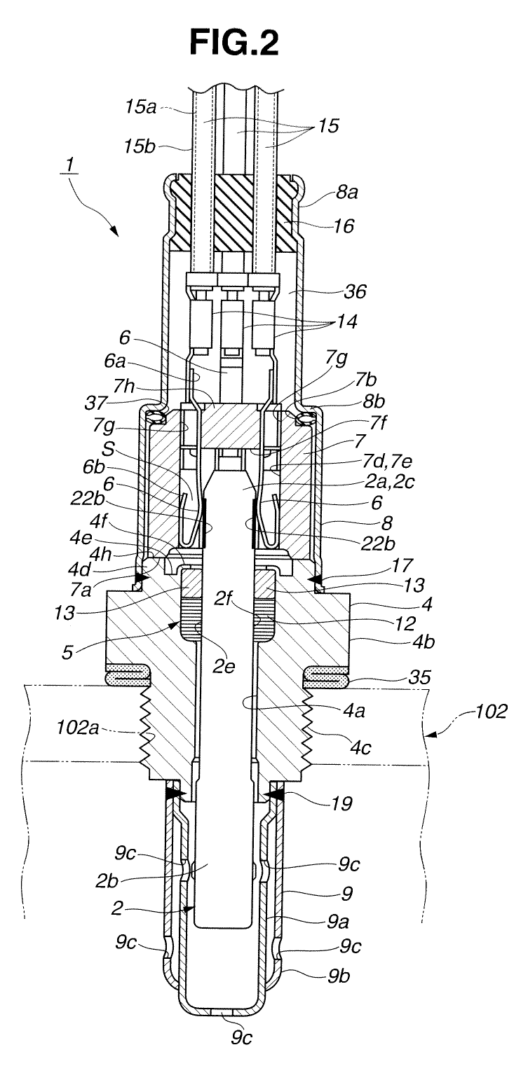

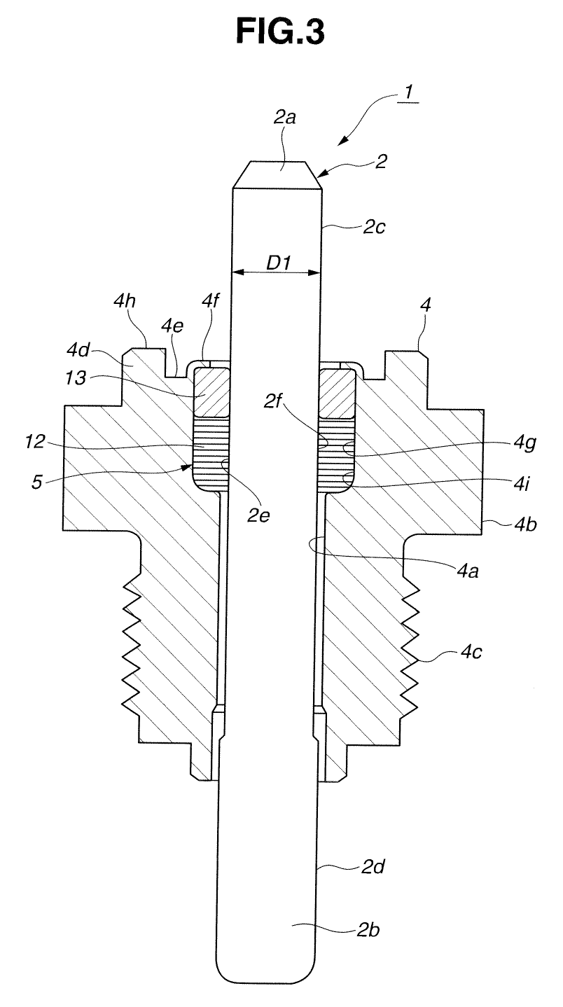

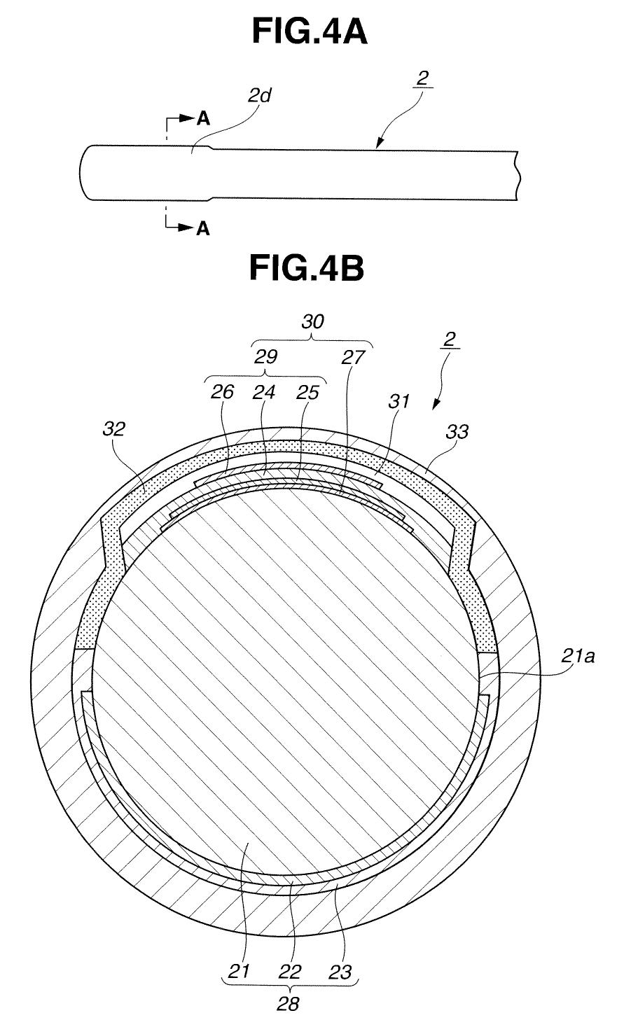

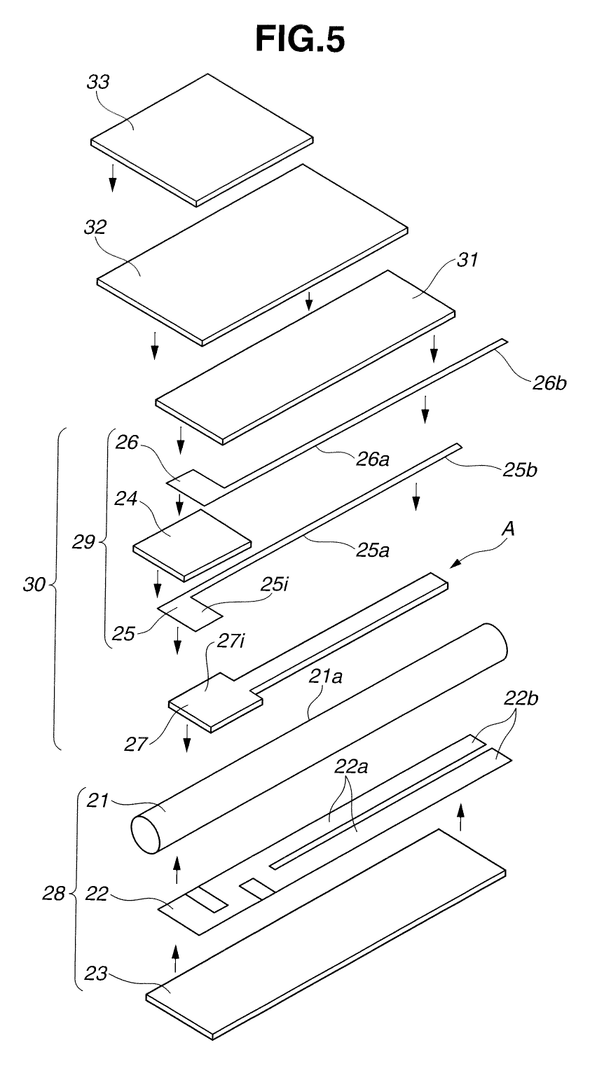

FIG. 1 is a side view showing a state where the oxygen sensor in an embodiment according to the present invention has been attached to the exhaust pipe. FIG. 2 is a cross-sectional view of the oxygen sensor (cross-sectional view taken along an axial direction of the oxygen sensor). FIG. 3 is an enlarged cross-sectional view (cross-sectional view taken along the axial direction) showing a main part of a sensing element. FIG. 4A is a side view of the sensing element. FIG. 4B is a cross-sectional view of FIG. 4A, taken along a line A-A, as viewed in a direction shown by arrows of FIG. 4A. FIG. 5 is an exploded view of the sensing element into respective layers.

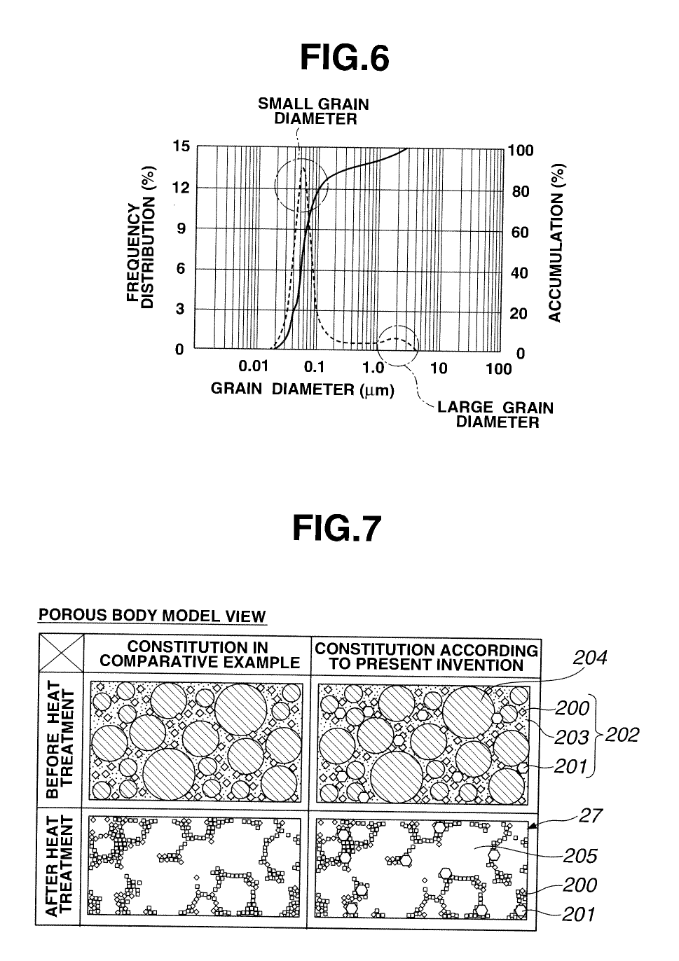

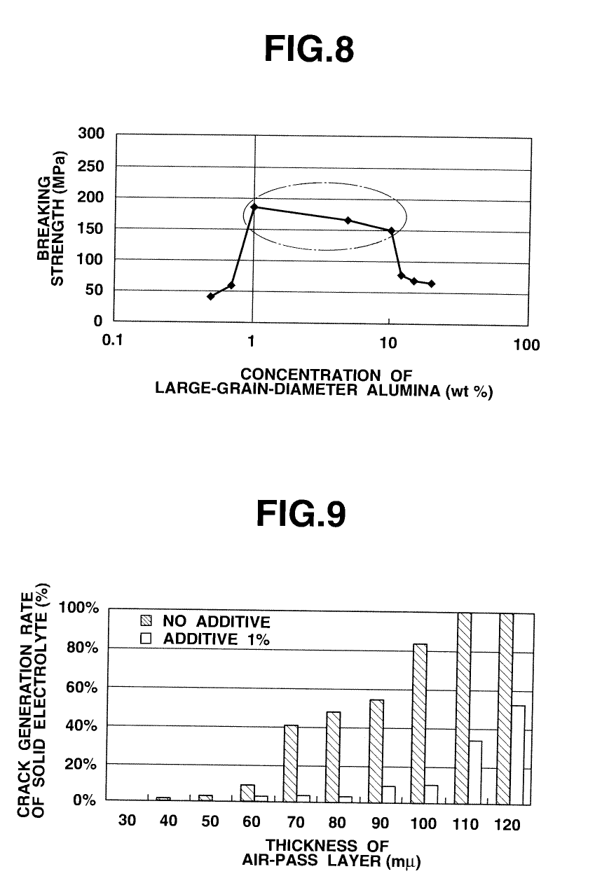

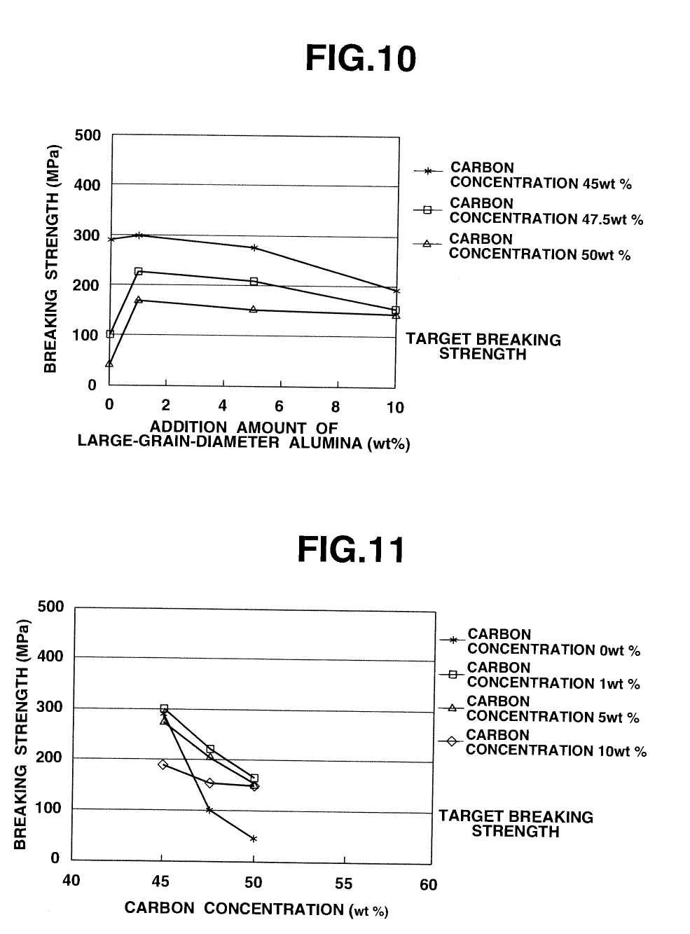

Moreover, FIG. 6 is a graph showing a grain (particle) size distribution of a ceramic material which forms an air-pass layer (ceramic layer) of the sensing element. FIG. 7 is a schematic view showing a structure of the air-pass layer according to the present invention and a structure of air-pass layer in a comparative technology. FIG. 8 is a characteristic view showing a relation between a breaking strength of the air-pass layer and a mixture ratio between one ceramic material having a small grain diameter (particle diameter) and another ceramic material having a large grain diameter. FIG. 9 is a characteristic view showing a relation between a coating thickness of the air-pass layer and a generation rate of crack in a solid electrolyte layer in a case that the another ceramic material having the large grain diameter is mixed, and in a case that the another ceramic material is not mixed. FIG. 10 is a characteristic view showing a relation between the breaking strength of air-pass layer and the mixture ratio between the one ceramic material having the small grain diameter and the another ceramic material having the large grain diameter, in a case that a carbon concentration at which the carbon is mixed into the ceramic materials is varied. FIG. 11 is a characteristic view showing a relation between the breaking strength of air-pass layer and the carbon concentration, in a case that the mixture ratio of the one ceramic material having the small grain diameter and the another ceramic material having the large grain diameter is varied.

At first, a schematic configuration of the oxygen sensor 1 in this embodiment will now be explained. As shown in FIG. 1, in this embodiment, the oxygen sensor 1 is provided to the exhaust pipe 102 at a location between an engine 101 and a catalyst 103. The catalyst 103 is disposed to the exhaust pipe 102 connected with the engine 101, and functions to purify exhaust gas of the engine 101. That is, the oxygen sensor 1 is located upstream of the catalyst 103 as shown in FIG. 1. However, according to this embodiment, the oxygen sensor 1 may be located downstream of the catalyst 103.

As shown in FIG. 2, the oxygen sensor 1 in this embodiment is formed substantially in a circular cylindrical shape having steps in its outer surface. The oxygen sensor 1 includes the sensing element 2, a holder 4, a seal portion 5, terminals 6, a glass (vitreous body) 7, a casing 8 and a protector 9. The sensing element 2 functions to detect a concentration of specific gas component which is included in a gas to be measured (measurement-target gas). The holder 4 is formed in a tubular (cylindrical) shape, and the sensing element 2 is passing through the holder 4. The seal portion 5 seals between the holder 4 and the sensing element 2, and sets a positioning of the sensing element 2 in the holder 4. The terminals 6 are connected with the sensing element 2. The glass 7 is disposed on one axial end portion (on an upper end side) of the holder 4, and is an insulator supporting the terminals 6. The casing 8 is disposed on the one axial end portion (on the upper end side) of the holder 4, and covers an outer surface of the glass 7. The protector 9 is fixed to another axial end portion (a lower end side) of the holder 4, and protrudes from the holder 4. The protector 9 covers an outer surface of the sensing element 2.

As shown in FIGS. 2 to 4, the sensing element 2 in this embodiment is formed in a rod shape, specifically in a shape of substantially circular-cylindrical column. The sensing element 2 includes a connecting portion 2a at one axial end portion (upper end portion) of the sensing element 2. The connecting portion 2a includes an output electrode 25b and heater electrodes 22b which will be mentioned below. Moreover, the sensing element 2 includes an oxygen sensing portion 2b at another axial end portion (lower end portion) of the sensing element 2. In detail, the sensing element 2 is formed in a shape of circular-cylindrical column having a step, since the sensing element 2 includes a small-diameter cylindrical column portion 2c having the connecting portion 2a, and a large-diameter cylindrical column portion 2d. An outer diameter of this large-diameter cylindrical column portion 2d is larger than an outer diameter D1 of the small-diameter cylindrical column portion 2c. The connecting portion 2a is formed in the small-diameter cylindrical column portion 2c, and the oxygen sensing portion 2b is formed in the large-diameter cylindrical column portion 2d. A tip (upper end portion) of the small-diameter cylindrical column portion 2c is chamfered over an entire (360°) circumference of the small-diameter cylindrical column portion 2c.

The output electrode 25b is exposed to an external space of the sensing element 2, and is electrically connected with the oxygen sensing portion 2b. In the sensing element 2, the oxygen sensing portion 2b senses oxygen as the specific gas component included in exhaust gas (which is regarded as a gas to be measured). As a result of this sensing, an oxygen concentration is outputted from the output electrode 25b by means of electric signals.

Moreover, as shown in FIGS. 2 and 3, the holder 4 is formed with an element insertion hole 4a into which the sensing element 2 is inserted (fitted). The sensing element 2 passing through this element insertion hole 4a is in a state where the oxygen sensing portion 2b is exposed external to the another axial end portion of holder 4 and where the connecting portion 2a is exposed external to the one axial end portion of holder 4. That is, the connecting portion 2a axially protrudes from one axial end of the holder 4, and the oxygen sensing portion 2b axially protrudes from another axial end of the holder 4.

The holder 4 includes a hexagonal portion 4b as an upper portion of the holder 4. The hexagonal portion 4b is in the form of hexagon as viewed from above (as viewed from a side of the casing 8). Accordingly, a rotation torque can be easily applied to the holder 4 by fitting a tool (rotating tool) over the hexagonal portion 4b. A threaded portion 4c is formed in an outer surface of lower portion of the holder 4. A gasket 35 is disposed between the hexagonal portion 4b and the threaded portion 4c of the holder 4.

Moreover, an axially convex portion 4d is formed in an upper surface of hexagonal portion 4b of holder 4. That is, the upper surface of holder 4 is formed to include an upper surface of the axially convex portion 4d. The upper surface of convex portion 4d abuts on a lower end surface 7a of the glass 7, and functions as a positioning surface 4h for supporting an end portion of glass 7 which is located close to the holder 4 (i.e., supporting a lower end portion of the glass 7). Moreover, a groove portion 4e is formed in the convex portion 4d. By bending an inner circumferential wall of this groove portion 4e, a caulked portion 4f is formed. The holder 4 is formed of a metal such as stainless, and has an electrically-conductive property.

The seal portion 5 includes a powder filling space (sealant storage space) 4g and the caulked portion 4f. The powder filling space 4g is located at one axial end portion of the element insertion hole 4a, and the caulked portion 4f is located near the powder filling space 4g. This powder filling space 4g is formed such that a hole diameter of the element insertion hole 4a is enlarged partly from a rear end of the holder 4 (from a side of the connecting portion 2a) toward a front end side of the holder 4 (toward a side of the oxygen sensing portion 2b), as shown in FIG. 3. The seal portion 5 encloses or receives a filler (sealant) 12 and a pressing member 13 for pressing the filler 12, in the powder filling space 4g. The pressing member 13 is compressed by the caulked portion 4f, since the caulked portion 4f has been deformed by a bending work using a method such as an entire-circumferential caulking in a direction radially toward a center of the sensing element 2 (i.e., in a radially inner direction of the sensing element 2). By this compressive force, the filler 12 is enclosed in a compressed state, namely, the powder filling space 4g is filled with the compressed filler 12. Thereby, a region between an outer surface 2e of the sensing element 2 and an inner circumferential surface 4i of the holder 4 is sealed by the seal portion 5. In addition, the seal portion 5 positions the sensing element 2 with respect to the holder 4. That is, the filler 12 sets a positioning of the sensing element 2 relative to the holder 4, in more detail, the pressing member 13 causes the filler 12 to position the sensing element 2 by pressing the filler 12.

The sealing between the outer surface 2e of sensing element 2 and the inner circumferential surface 4i of holder 4, which is achieved by the seal portion 5, prevents external moisture or the like from entering an inside of holder 4 and also prevents the exhaust gas or the like within the exhaust pipe 102 from entering an inside of the casing 8. That is, the seal portion 5 functions to block passages of moisture, exhaust gas and the like.

As the pressing member 13, for example, a ring member formed in a tubular shape is used in this embodiment.

Moreover, in this embodiment, a non-sintered talc is used as the filler 12. This filler 12 is being pushed by the pressing member 13 so that the seal portion 5 functions. According to the present invention, a ceramic powder such as steatite may be used as the filler 12 instead of the talc.

The number of terminals 6 is four in this embodiment. The four terminals 6 respectively correspond to the output electrode 25b of sensing element 2, a ground electrode 26b and a pair of heater electrodes 22b. These four terminals 6 are arranged approximately at intervals of 90 degrees around a shaft center (axis) of oxygen sensor 1. Each terminal 6 is formed by processing a plate material, for example, by means of a bending work. Each terminal 6 includes a contact portion 6a formed substantially in a to plate shape at one end portion of the terminal 6. Another end portion of each terminal 6 is formed in a shape capable of having a spring property. Specifically, each terminal 6 includes a spring portion 6b formed in a hook shape at another end portion of the terminal 6. The spring portion 6b functions as a leaf spring. This spring portion 6b is formed by processing the plate material by means of a return (fold) processing.

The terminals 6 are disposed on the one axial end side of the holder 4. The spring portions 6b of terminals 6 are respectively in contact with the output electrode 25b, the ground electrode 26b and the pair of heater electrodes 22b of the sensing element 2 which extend and project from the holder 4 in the one axial direction of holder 4, by use of its spring property.

The contact portion 6a of each terminal 6 is connected through a binding portion 14 with an after-mentioned core wire 15a of a harness 15. The contact portion 6a is fixed to the binding portion 14 by means of spot welding or the like. The binding portion 14 is formed of a material having a electrically-conductive property, such as metallic material. Hence, the oxygen sensing portion 2b of the sensing element 2 is electrically connected through the output electrode 25b, the ground electrode 26b, the terminals 6 and the binding portions 14 with the core wires 15a of harnesses 15.

The number of harnesses 15 is three. These three harnesses 15 are provided to correspond to the output electrode 25b and the pair of heater electrodes 22b of the sensing element 2. The harness 15 includes the core wire 15a and a covering material 15b which is coating or covering the core wire 15a. An end portion of the core wire 15a is not covered by the covering material 15b, and this exposed portion of core wire 15a is connected with the binding portion 14.

The casing 8 is formed in a tubular shape to cover the glass 7. On an inner side of one axial end portion of the casing 8, a sealing rubber 16 is provided. Through this sealing rubber 16, the harnesses 15 are introduced from the inside of the casing 8 to an outside of the casing 8. The sealing rubber 16 is fixed to the casing 8 by a caulking provided at a caulked portion 8a of the casing 8. Therefore, the sealing rubber 16 is fastened in a state where the sealing rubber 16 is being compressed in a direction toward a center of sealing rubber 16 (in the radially inner direction) so as to reduce an outer diameter of the sealing rubber 16. By this caulking, a sealing performance (gas tightness) between the sealing rubber 16 and the harnesses 15 and a sealing performance (gas tightness) between the sealing rubber 16 and the casing 8 are ensured. The sealing rubber 16 is formed of a material having a heat resistance property, such as fluorine-contained rubber.

Another axial end portion of the casing 8 is fitted over the holder 4, and is fixed to the holder 4 by means of welding such as a laser welding (all-around welding), as shown by a sign 17 in FIG. 1. By this welding, a sealing performance between the casing 8 and the holder 4 is ensured. An inner diameter of the casing 8 is sufficiently larger than an outer diameter of the glass 7. Thereby, a cavity (hollow) portion 36 is formed between the casing 8 and the glass 7.

As shown in FIG. 2, an outline form of the glass 7 in this embodiment is approximately in a shape of circular-cylindrical column. The glass 7 is disposed on the positioning surface 4h of the holder 4 in a standing position.

This glass 7 is formed of an insulating material such as ceramic.

A concave portion 7d is formed in the lower end surface (another end surface) 7a of the glass 7. The concave portion 7d is recessed in the one axial direction (toward a side of harness 15 or sealing rubber 16). Along an inner circumferential surface 7e of this concave portion 7d, the plurality of spring portions 6b of terminals 6 are arranged. The connecting portion 2a of sensing element 2 is fitted between the plurality of terminals 6. That is, in a state that the glass 7 and the sensing element 2 have been mounted, the spring portions 6b of terminals 6 are disposed in a space S formed between an outer surface of the connecting portion 2a of sensing element 2 and the inner circumferential surface 7e of concave portion 7d of glass 7, and thereby the spring portions 6b of terminals 6 are held by being sandwiched between the inner circumferential surface 7e of concave portion 7d and the connecting portion 2a of sensing element 2. The terminals 6 sandwiched and held in this manner are in press-contact with the connecting portion 2a of sensing element 2 by repulsive force generated at the spring portions 6b because of this sandwiched state. Thereby, the terminals 6 are electrically connected with the connecting portion 2a.

In a ceiling portion (a recess bottom) 7f of the concave portion 7d, a plurality of mounting holes 7g are formed at intervals in the circumferential direction. That is, an upper portion of the glass 7 is formed with the plurality of through-holes 7g into which the terminals 6 are inserted. Since the three terminals 6 are provided in correspondence with the output electrode 25b and the pair of heater electrodes 22b of the sensing element 2 in this embodiment, the sensing element 2 which is held to be sandwiched by these terminals 6 becomes easy to be located approximately at a center of the concave portion 7d in a case that these terminals 6 are arranged at regular intervals in the circumferential direction of glass 7.

In the space S given between the glass 7 and the connecting portion 2a of sensing element 2, air tightness is secured by the seal portion 5, the sealing rubber 16 and the welded portion 17 provided between the casing 8 and the holder 4. However, the space S is communicated with an outside of the oxygen sensor 1 through only a minute gap given between the core wire 15a and the covering material 15b in the harness 15. By this communication, a reference atmosphere which is used for the detection of oxygen concentration is introduced into the inside of casing 8.

The glass 7 includes an upper end portion 7h on a side opposite to the holder 4. In an outer circumferential surface of the upper end portion 7h, a step portion 7b is formed in an annular shape along the circumferential direction of glass 7. That is, the upper end portion 7h is formed with the step portion 7b having an outer diameter smaller than the other portions of glass 7. An elastic member 37 is fitted over this step portion 7b. The casing 8 is also formed with an annular-shaped step portion (diameter-reducing portion) 8b corresponding to the step portion 7b. The step portion 7b of glass 7 and the step portion 8b of casing 8 hold the elastic member 37 in a compressed state by sandwiching the elastic member 37 between the step portions 7b and 8b. The elastic member 37 is formed, for example, in a C-ring shape or an O-ring shape. By such a structure, the glass 7 is pressed to the holder 4 and also a vibration of the glass 7 is suppressed by means of elastic force of the elastic member 37. Moreover, if the oxygen sensor 1 vibrates due to an external force, a swing (vibration) of glass 7 is absorbed or suppressed because of an elastic deformation of elastic member 37. Accordingly, a vibration proof (vibration resistance) of the oxygen sensor 1 can be improved.

The protector 9 is formed in a tubular shape having its bottom, and is formed in a double structure. The protector 9 is fixed to the holder 4 by an all-around welding or spot welding such as laser welding, or by an all-around caulking or spot caulking or the like. In FIG. 2, a welded part 19 is shown as the case where the fixation of protector 9 is performed by means of welding.

The protector 9 includes an inner protector 9a and an outer protector 9b. These inner protector 9a and outer protector 9b are formed of, for example, a metallic material and/or ceramic material. The oxygen sensing portion 2b of sensing element 2 which is protruding downwardly from the holder 4 is inserted into an inside of the protector 9. The protector 9 having such structures protects the oxygen sensing portion 2b from foreign substances included in the exhaust gas or the like, by covering the oxygen sensing portion 2b of sensing element 2.

The protector 9 is formed with communication holes 9c for gas communication. The detection gas (gas to be detected) passes through the communication holes 9c, and thereby enters the inside of protector 9. Then, the gas reaches the oxygen sensing portion 2b.

The oxygen sensor 1 is fixed to the exhaust pipe 102 by screwing down the threaded portion 4c of holder 4 into a threaded hole 102a of exhaust pipe 102. Accordingly, the oxygen sensor 1 is positioned in a state that a portion of oxygen sensor 1 which has been covered by the protector 9 is protruding into an inside of exhaust pipe 102. Air tightness and liquid tightness between the oxygen sensor 1 and the exhaust pipe 102 are ensured by the gasket 35.

When the gas flowing within the exhaust pipe 102 flows through the communication holes 9c into the inside of protector 9, oxygen included in the gas enters the oxygen sensing portion 2b of sensing element 2. Thereby, the oxygen sensing portion 2b senses the oxygen concentration, and converts this sensed oxygen concentration into an electric signal. An information of this electric signal is outputted through the terminals 6 and the harness 15 to the outside of oxygen sensor 1.

Next, configurations related to the sensing element 2 will now be explained.

As shown in FIGS. 4A, 4B and 5, the sensing element 2 includes a base body (substrate) 21 formed in a long and thin cylindrical-rod shape. The base body 21 is formed of a ceramic material such as alumina which serves as an insulating material. The output electrode 25b constituting the connecting portion 2a, the oxygen sensing portion 2b and the like are formed on the base body 21. Since the base body 21 of sensing element 2 is designed in the cylindrical-rod shape; the oxygen sensor 1 can be more compact and can be prevented from receiving influences due to a mounting direction of oxygen sensor 1 and a flow direction of gas or the like.

A heater pattern 22 is formed on a surface 21a of the base body 21, and is coated with an insulating layer 23. The base body 21, the heater pattern 22 and the insulating layer 23 constitute a heater portion 28.

The heater pattern 22 is formed of, for example, an exothermic (heating) conductive material such as a platinum mixed with alumina. The heater pattern 22 is formed on the surface 21a of base body 21 by means of a curved surface printing or the like. Moreover, a pair of lead portions 22a extending from a front end portion (lower end portion) of base body 21 toward a rear end portion of base body 21 (toward the side of terminals 6) are integrally combined with the heater pattern 22 in a connected row arrangement. At the rear end portion of base body 21, each lead portion 22a constitutes the heater electrode 22b. These heater electrodes 22b are connected with the terminals 6 as shown in FIG. 2. The heater pattern 22 functions to heat the base body 21, for example, to a temperature ranging from 720° C. to 800° C., by a power feeding obtained through the respective lead portions 22a from an external heater power source (not shown).

The insulating layer 23 is provided for protecting the heater pattern 22 and the lead portions 22a from radially outside thereof. This insulating layer 23 is formed by applying a thick-film printing of a ceramic material such as alumina to an outer circumferential side of the base body 21, for example, by means of a curved surface printing or the like.

Moreover, a functional layer 30 and a protective layer 31 are formed on the surface 21a of base body 21 at a circumferentially different location from the heater pattern 22, as shown in FIG. 4B. The protective layer 31 coats an outer surface of the functional layer 30. These functional layer 30 and the protective layer 31 are formed in a laminated manner by means of a curved surface printing or the like. In this embodiment, these functional layer 30 and protective layer 31 are provided on a portion of surface 21a of base body 21 which is located radially (diametrically) opposed to the heater pattern 22.

The functional layer 30 includes a solid electrolyte layer 24, a reference electrode layer 25, a sensing electrode layer 26 and the air-pass layer 27. The solid electrolyte layer 24 has an oxygen-ion conductivity. The reference electrode layer 25 is located between the solid electrolyte layer 24 and the base body 21. The sensing electrode layer 26 is located opposed to the reference electrode layer 25 relative to the solid electrolyte layer 24, namely, the solid electrolyte layer 24 is provided between the reference electrode layer 25 and the sensing electrode layer 26. The air-pass layer 27 is located between the solid electrolyte layer 24 and the base body 21. The air-pass layer 27 guides an outside air (atmospheric air) which serves as a reference gas, toward the solid electrolyte layer 24.

The solid electrolyte layer 24 is, for example, formed of a paste substance obtained by mixing a powder of zirconia with a predetermined weight-percentage of a powder of yttria. The solid electrolyte layer 24 generates an electromotive force according to a surrounding oxygen-concentration difference, between the reference electrode layer 25 and the sensing electrode layer 26. The solid electrolyte layer 24 transports or moves oxygen ion in a thickness direction of solid electrolyte layer 24.

Accordingly, the solid electrolyte layer 24 and the pair of electrode layers (the reference electrode layer 25 and the sensing electrode layer 26) define an oxygen measuring portion 29 for measuring and deriving the oxygen concentration as an electric signal.

Moreover, a part of the solid electrolyte layer 24 abuts on the air-pass layer 27. That is, at least a part of the air-pass layer 27 is formed at an interface between the base body 21 and the solid electrolyte layer 24.

Each of the reference electrode layer 25 and the sensing electrode layer 26 is formed of a material including platinum or the like, which has an electrically-conductive property and an oxygen-transmission (oxygen-pass) property. A lead portion 25a extends from the reference electrode layer 25, and is provided integrally with the reference electrode layer 25. In the same manner, a lead portion 26a extends from the sensing electrode layer 26, and is provided integrally with the sensing electrode layer 26. By use of these lead portions 25a and 26a, the output voltage generated between the reference electrode layer 25 and the sensing electrode layer 26 can be detected. Specifically, the end portion of lead portion 25a which is located opposite to the reference electrode layer 25 forms the output electrode 25b functioning as an electrode portion. In the same manner, the end portion of lead portion 26a which is located opposite to the sensing electrode layer 26 forms the ground electrode 26b functioning as the electrode portion. The ground electrode 26b and the output electrode 25b exit in an extended condition beyond the protective layer 31 in the one axial direction (upper direction) of base body 21, and are exposed to an outside of the sensing element 2. (not shown) That is, the ground electrode 26b and the output electrode 25b are provided at an outer circumference of the sensing element 2.

The air-pass layer 27 is formed, for example, by printing a paste substance formed of a powder of alumina (or a powder of alumina mixed with a predetermined weight-percentage of a powder of zirconia) on the surface 21a of base body 21 by means of thick-film printing. That is, the air-pass layer 27 is formed in an annular shape on the outer circumferential surface of base body 21 by method of a curved surface printing or the like.

Moreover, the air-pass layer 27 is formed to have a porous structure, namely has vacancies (pores) formed by interconnected air bubbles (open-cells of air void). A part of the measurement-target gas (gas to be measured) flowing near the sensing element 2 is diffused from one axial end surface of air-pass layer 27 to an inside of the air-pass layer 27, in a direction of arrow “A” (axial direction) shown in FIG. 5. Moreover, the air-pass layer 27 functions to transmit the measurement-target gas toward the reference electrode layer 25.

Moreover, in this embodiment, a region 27i of air-pass layer 27 which is located radially opposed to the solid electrolyte layer 24 is formed to have a smaller area (planar dimension) than that of the solid electrolyte layer 24. The region 27i is formed of a ceramic composite including an insulating material (e.g., alumina) and a solid electrolyte (e.g., zirconia). Hence, when the solid electrolyte layer 24 undergoes sintering, a stress difference between the solid electrolyte layer 24 and the base body 21 is eased by virtue of the region 27i.

Moreover, the region 27i of air-pass layer 27 has the area value (planar dimension) greater than that of a region 25i of the reference electrode layer 25. Hence, the measurement-target gas diffused in the direction of arrow “A” can be favorably passed into the reference electrode layer 25.

The air-pass layer 27 is compressed by the filler 12. Specifically, the powder filling space 4g is provided on all-around outer circumference of the element insertion hole 4a of holder 4. The pressing member 13 is pressed by the caulked portion 4f to which the bending work has been applied in the radially inner direction of the sensing element 2 by means of all-around caulking or the like. Thereby, the filler 12 becomes in a pressurized state, so that the sensing element 2 can be positioned relative to the holder 4. This filler 12 packed in the pressurized state fills a clearance or the like between the holder 4 and the sensing element 2, and blocks external moisture or the like from entering into the holder 4. Moreover, the filler 12 blocks exhaust gas within the exhaust pipe or the like from moving to the side of casing 8. By this structure, a pressure receiving portion 2f of air-pass layer 27 which corresponds to a location of the filler 12 is compressed, i.e., receives a load caused by the filler 12.

On an outer surface of the functional layer 30 except the solid electrolyte layer 24 (i.e., on outer surfaces of the lead portion 25a, the lead portion 26a and a part of the air-pass layer 27), the protective layer 31 is provided. On outer surfaces of the protective layer 31 and the insulating layer 23, a diffusion layer 32 is formed to cover or coat the protective layer 31 and the solid electrolyte layer 24. On an outer surface of this diffusion layer 32, a spinel protective layer 33 is formed to cover or coat a region including the outer surface of the diffusion layer 32.

The protective layer 31 is formed of a material which prevents oxygen included in the measurement-target gas (gas to be measured) from penetrating the protective layer 31 in an inner-surface direction. For example, the protective layer 31 is formed of a ceramic material such as alumina. This protective layer 31 is formed on a region except both the electrode layers 25 and 26 and a part of outer surface of the solid electrolyte layer 24, namely for example, is formed so as to expose the sensing electrode layer 26.

The diffusion layer 32 is formed of a material which prevents toxic gas, dust and the like included in the measurement-target gas from penetrating the diffusion layer 32 in the radially-inner direction and also which allows oxygen included in the measurement-target gas to penetrate (pass through) the diffusion layer 32 in the radially-inner direction. For example, the diffusion layer 32 is made by a porous body formed of a mixture of alumina and magnesium oxide.

The spinel protective layer 33 cooperates with the protective layer 31 and the diffusion layer 32 to coat the outer surfaces of the functional layer 30 and the heater portion 28. The spinel protective layer 33 has a porous structure allowing oxygen included in the measurement-target gas to pass through the spinel protective layer 33. The spinel protective layer 33 is made by a porous body coarser than the protective layer 31.

The sensing element 2 is formed by a sequence of printing processes.

Specifically, at first, the base body 21 is manufactured by an injection molding of a ceramic material such as alumina. Then, while rotating this base body 21, the heater pattern 22, the lead portions 22a and the insulating layer 23 are formed on the surface 21a of base body 21 in an approximately half range of the surface 21a by means of curved-surface screen printing.

Next, the air-pass layer 27 is formed on the surface 21a in another half range of the surface 21a which is located opposite to the range of heater pattern 22, by means of curved-surface screen printing.

Next, the reference electrode layer 25 and its lead portion 25a are integrally formed by printing an electrically-conductive paste made of platinum and the like, on the surface 21a of base body 21 and the air-pass layer 27, by means of curved-surface screen printing.

Next, the solid electrolyte layer 24 having an oxygen-ion conductivity is formed by printing a paste substance formed of zirconia and yttria or the like, on outer surfaces of the reference electrode layer 25 and the air-pass layer 27, by means of curved-surface screen printing. This solid electrolyte layer 24 is greater in area than the air-pass layer 27 (region 27i).

Next, the sensing electrode layer 26 and its lead portion 26a are integrally formed by printing an electrically-conductive paste made of platinum and the like, on the outer surface of solid electrolyte layer 24, by means of curved-surface screen printing.

By so doing, the functional layer 30 is formed. Then, the protective layer 31 is formed, for example, by printing a paste substance formed of alumina and magnesium oxide on outer surfaces of the sensing electrode layer 26 and the solid electrolyte layer 24, by means of curved-surface screen printing.

The protective layer 31 is formed to cover both the lead portions 25a and 26a of electrode layers 25 and 26 and a part of air-pass layer 27. The protective layer 31 functions to protect the lead portions 25a and 26a, and to seal the air-pass layer 27.

Thus, since the protective layer 31 covers the both the lead portions 25a and 26a of electrode layers 25 and 26 and the part of air-pass layer 27, a leakage of air introduced into the air-pass layer 27 can be reliably prevented.

Next, the diffusion layer 32 is formed to cover a part of each outer surface of the solid electrolyte layer 24, the protective layer 31 and the insulating layer 23.

The diffusion layer 32 becomes in a porous structure after a firing, and functions to protect the solid electrolyte layer 24 and to diffuse the measurement-target gas to the sensing electrode layer 26.

Next, the spinel protective layer 33 is formed by printing a paste substance formed of, e.g., alumina and magnesium oxide, not only on the outer surfaces of sensing electrode layer 26 and solid electrolyte layer 24 but also on the outer surface of insulating layer 23, by means of curved-surface screen printing. That is, the spinel protective layer 33 is provided over an outer entire-circumferential region (all-round region) of base body 21. By so doing, a cylindrical object is produced, and then, such curved-surface screen printing processes are finished.

Then, the cylindrical object produced by the sequence of printing processes is fired at high temperature (for example, 1400˜1500° C), and thereby the integrally-sintered sensing element 2 can be obtained. With regard to the air-pass layer 27, an admixture ingredient of zirconia and aluminum is further mixed with a vacancy (pore) forming agent (vanishing agent) such as carbon (average grain diameter: 2˜16 μm). Then, a patterning of this mixed material is performed, and is fired, so that the air-pass layer 27 having the porous structure is formed.

Moreover, with regard to the reference electrode layer 25, a mixture obtained by mixing a noble metal material (for example, platinum) with a vacancy forming agent such as theobromine is used for performing a patterning. Then, the patterned mixture is fired. Thereby, the vacancy forming agent burns out to form vacancies within electrode at the time of firing of the patterned mixture. Accordingly, the reference electrode layer 25 can have a porous structure.

The air-pass layer 27 functions as a gas escaping passage for allowing the oxygen transported through the solid electrolyte layer 24 to the reference electrode layer 25, to escape through some route (not shown). The air-pass layer 27 in this embodiment is formed by mixing the ceramic composite with a vacancy forming agent. Thus, since the air-pass layer 27 is formed by using the vacancy forming agent, the vacancy forming agent burns out at the time of firing so that vacancies (pores) are formed within layer. Accordingly, the air-pass layer 27 can have the porous structure. Therefore, a surplus oxygen supplied from the reference electrode layer 25 can be discharged to the end portion of sensing element 2, so that an element crack due to an increase of oxygen pressure can be prevented.

It is noted that the sensing element 2 corresponds to a ceramic structural member according to the present invention, which includes the base body 21 formed of an insulating material and includes the porous air-pass layer (ceramic layer) 27 formed integrally with the base body 21.

Generally, as a grain diameter of ceramic material becomes smaller (as a specific surface area becomes larger), a contact area of grain boundary becomes larger. Hence, in a case that the grain diameter is small, a moving amount (displacement) at the time of solution is small so that an energy can be reduced. As a result, a sintering temperature can be lowered. That is, in this case, there is an advantage that the ceramic material becomes easy to be sintered. However, if the air-pass layer 27 is formed by using a ceramic material having such a small grain diameter in a condition of approximately constant size, there are many grain boundaries which might act as origin points of crack so that it becomes difficult to increase a binding strength. That is, there has been a problem that it is difficult to enhance the breaking strength of air-pass layer 27.

Therefore, according to the present invention, the air-pass layer 27 is formed of an admixture 202 obtained by mixing a ceramic material 200 having a small grain diameter with a ceramic material 201 having a large grain diameter. Thereby, the ceramic material 201 having the large grain diameter is scattered (dotted) in the ceramic material 200 having the small grain diameter, so that a pressure of grain boundary is increased to enhance the binding strength.

The admixture 202 is used at least for the pressure receiving portion 2f which is pressed by the filler 12. It is preferable that the admixture 202 is used over the entire range of air-pass layer 27 including the range of pressure receiving portion 2f.

In this embodiment, it is preferable that the admixture 202 includes the ceramic material 200 having a specific surface area (surface area per unit) falling within a range from 8 to 20 m²/g or having a grain diameter falling within a range from 0.05 to 0.5 μm which is indicated when an accumulation of grain size distribution in weight accumulation is equal to 50%, as a main material; and includes the ceramic material 201 (mixed with the ceramic material 200) having a specific surface area falling within a range from 0.5 to 2.0 m²/g or a grain diameter falling within a range from 0.8 to 5.0 μm which is indicated when an accumulation of the grain size distribution in weight accumulation is equal to 50%. In this embodiment, it is more preferable that the admixture 202 includes the ceramic material 200 having a specific surface area falling within a range from 12 to 15 m²/g or a grain diameter falling within a range from 0.1 to 0.3 μm which is indicated when an accumulation of the grain size distribution in weight accumulation is equal to 50%, as the main material; and includes the ceramic material 201 having a specific surface area falling within a range from 0.9 to 1.3 m²/g or a grain diameter falling within a range from 1.0 to 2.0 μm which is indicated when an accumulation of the grain size distribution in weight accumulation is equal to 50%. It is noted that the ceramic material 200 corresponds to one ceramic material according to the present invention, and the ceramic material 201 corresponds to another ceramic material according to the present invention.

In this embodiment, the grain sizes of the ceramic materials 200 and 201 were measured by a known grain-size analyzer (for example, a registered trademark “MICROTRAC”), and the specific surface areas of the ceramic materials 200 and 201 were measured by a known BET method.

In this embodiment, it is preferable that the admixture 202 includes the ceramic material 200 at a rate falling within a range from 90 to 99 wt % (weight-percentage), and the ceramic material 201 at a rate falling within a range from 1 to 10 wt %.

Moreover, in this embodiment, it is preferable that the air-pass layer 27 is formed to have its film thickness falling within a range from 5 μm to 100 μm, and to have a porosity falling within a range from 50% to 70% at this time.

The measurements of the porosity and the thickness are measured by a measuring method in which a cross-sectional image of test sample is captured and analyzed to calculate an occupied area (planar dimension) of air pores by using a scanning electron microscope (SEM).

In a case that the porosity of the air-pass layer 27 is lower than 50%, a diffusion speed of the outside air passing through the air-pass layer 27 is reduced so that it becomes difficult to sufficiently introduce the outside air to the reference electrode layer 25. On the other hand, in a case that the porosity of air-pass layer 27 is higher than 70%, there is a risk that the strength of air-pass layer 27 is reduced.

The above-mentioned preferable porosity can be is achieved by mixing the ceramic material for forming the air-pass layer 27 with a carbon 204 having an average grain diameter falling within a range from 1 μm to 20 μm as vacancy forming agent. At this time, the carbon 204 is mixed at a rate falling within a range from 45 wt°/0 to 55 wt % in weight percentage with respect to a total of the ceramic material and the carbon 204. In this embodiment, the carbon is used as the vacancy forming agent as explained above. However, according to the present invention, the vacancy forming agent is not limited to the carbon, and various materials can be used as the vacancy forming agent.

The porosity of the air-pass layer 27 is defined by a rate of volume of pores (vacancies) 205 to a predetermined unit volume of the air-pass layer 27. The carbon 204 used as the vacancy forming agent burns out at the time of firing of the sensing element 2, so that the pores (vacancies) constituting the interconnected air bubbles are formed in the air-pass layer 27.

In this embodiment, as shown in FIGS. 6 and 7, the ceramic material 200 having a grain diameter equal to 0.05 μm at the accumulation in grain size distribution equal to 50% is mixed with an organic vehicle 203 so that the paste for screen printing is formed. This paste is added to the ceramic material 201 having a grain diameter equal to 2.0 μm at the accumulation in grain size distribution equal to 50%, so that the admixture 202 is formed. At this time, the ceramic material 201 is used to account for 1 wt % of the total of ceramic material 200 and ceramic material 201. Then, the carbon 204 is added to the admixture 202 as the vacancy forming agent so as to allow the carbon 204 to account for 45 wt % of the total of admixture 202 and carbon 204. Then, this mixture of the carbon 204 and the admixture 202 is dispersed (well-mixed) evenly by a triple roll mill. Then, the dispersed paste substance is fired, so that the air-pass layer 27 of porous structure including the pores 205 is formed.

The organic vehicle 203 is a medium constituted by a solvent component and a resin component serving as a binder. Each of the solvent component and the resin component is not limited to a specified one, and a material which has been conventionally widely used as a paste for screen printing can be used as the solvent component or the resin component in this embodiment.

Next, advantageous effects according to the mixing of the plurality of ceramic materials having grain size distributions different from each other will now be explained.

At first, as recognized by a graph of FIG. 8, in a case that the ceramic material 200 is mixed with the ceramic material 201 having a grain diameter greater than that of the ceramic material 200 so as to allow the ceramic material 201 to account for 1˜10 wt % of the total of ceramic materials 200 and 201, the breaking strength of air-pass layer is greater than the other cases of mixture ratio.

That is, by adding the ceramic material 201 falling within a range from 1 to 10 wt % to the ceramic is material 200, the breaking strength of air-pass layer can be made greater than 100 (MPa) which is a target breaking strength. Moreover, in a case that the thickness of air-pass layer 27 is formed to become thin; a space volume needs to be secured, and the breaking strength is reduced. However, in the structure of this embodiment, the thickness of air-pass layer 27 can be made thin (for example, about 5 μm) because the strength can be secured.

Although the target breaking strength of air-pass layer has been mentioned as 100 (Mpa), the value of 100 (Mpa) has been just conveniently set as a strength capable of improving a manufacturing yield of the oxygen sensor 1. That is, the breaking strength of air-pass layer is not necessarily made greater than 100 (Mpa).

In this embodiment, the measurement of the breaking strength was conducted by a three-point bending test based on ES (Japanese Industrial Standards).

Moreover, as recognized by a graph of FIG. 9, in a case that the ceramic material 200 is mixed with the ceramic material 201 so as to allow the ceramic material 201 to account for 1 wt % of the total of ceramic materials 200 and 201, the crack of solid electrolyte layer which occurs at the time of manufacturing can be suppressed than a case that the ceramic material 201 is not used. Specifically, in cases that the thickness of air-pass layer is made thick, a rise of generation rate of crack is suppressed to a low level (for example, the generation rate of crack can be suppressed to be lower than or equal to 10% in the cases that the thickness of air-pass layer is smaller than or equal to 100 μm).

That is, by adding the ceramic material 201 accounting for 1 wt % to the ceramic material 200; the manufacturing yield of the oxygen sensor 1 can be enhanced, and also, the thickness of air-pass layer can be made thick. It is noted that an additive described in FIG. 9 means the ceramic material 201.

Moreover, as shown in FIG. 10, in the cases that the ceramic material 200 is mixed with the ceramic material 201 so as to allow the ceramic material 201 to account for a rate falling within the range from 1 wt % to 10 wt % of the total of ceramic materials 200 and 201, the breaking strength of air-pass layer can be made greater than the value of 100 (Mpa) set as the target breaking strength even if the concentration of the carbon 204 which is added for forming the pores is varied from 45 wt % to 50 wt %.

Thus, by adding the ceramic material 201 ranging from 1 to 10 wt % to the ceramic material 200, it can be suppressed that the breaking strength of air-pass layer is reduced when the porosity of air-pass layer is made high.

Moreover, as shown in FIG. 11, in a case that the concentration of carbon 204 which is added for forming the pores 205 is set equal to 45 wt %, the breaking strength of air-pass layer can be further enhanced while suppressing the reduction of diffusion speed of outside air passing through the air-pass layer.

As explained above, in the oxygen sensor 1 according to this embodiment, the porous air-pass layer (ceramic layer) 27 which is integrated with the base body 21 made of an insulating material is formed of the admixture obtained by mixing the plurality of ceramic materials whose grain size distributions are different from each other. Accordingly, the strength of air-pass layer 27 can be enhanced. By using the sensing element 2 formed with such air-pass layer 27, it can be suppressed that the sensing element 2 is broken (cracked) at the time of manufacturing of oxygen sensor (gas sensor) 1. Also, it can be suppressed that at least the pressure receiving portion 2f of air-pass layer 27 formed inside the sensing element 2 is buckled or damaged due to the pressure applied by the filler 12.

Furthermore, in this embodiment, the oxygen sensor 1 can become compact since the sensing element 2 is formed in a rod shape.

This application is based on a prior Japanese Patent Application No. 2009-064720 filed on Mar. 17, 2009. The entire contents of this Japanese Patent Application are hereby incorporated by reference.

Although the invention has been described above with reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A gas sensor including a ceramic structural member, the ceramic structural member comprising:
a base body formed of an insulating material; and
a porous ceramic layer formed integrally with the base body,
wherein the ceramic layer is formed of an admixture of a plurality of ceramic materials, the plurality of ceramic materials having grain size distributions different from each other.

2. The gas sensor including the ceramic structural member according to claim 1, wherein
the admixture includes one ceramic material having a grain diameter falling within a range from 0.05 to 0.5 μm which is indicated when an accumulation in the grain size distribution is equal to 50%, and another ceramic material having a grain diameter falling within a range from 0.8 to 5.0 μm which is indicated when the accumulation in the grain size distribution is equal to 50%.

3. The gas sensor including the ceramic structural member according to claim 1, wherein
the admixture includes one ceramic material having a grain diameter falling within a range from 0.1 to 0.3 μm which is indicated when an accumulation in the grain size distribution is equal to 50%, and another ceramic material having a grain diameter falling within a range from 1.0 to 2.0 um which is indicated when the accumulation in the grain size distribution is equal to 50%.

4. The gas sensor including the ceramic structural member according to claim 1, wherein
the admixture includes one ceramic material having a specific surface area falling within a range from 8 to 20 m²/g, and another ceramic material having a specific surface area falling within a range from 0.5 to 2.0 m²/g.

5. The gas sensor including the ceramic structural member according to claim 1, wherein
the admixture includes one ceramic material having a specific surface area falling within a range from 12 to 15 m²/g, and another ceramic material having a specific surface area falling within a range from 0.9 to 1.3 m²/g.

6. The gas sensor including the ceramic structural member according to claim 2, wherein
the admixture includes the one ceramic material at a rate falling within a range from 90 to 99 wt %, and the another ceramic material at a rate falling within a range from 1 to 10 wt %.

7. The gas sensor including the ceramic structural member according to claim 1, wherein
the admixture is added to a pore forming agent accounting for a rate falling within a range from 45 to 50 wt % of a total of the admixture and the pore forming agent; and
the admixture is sintered to form the ceramic layer.

8. The gas sensor including the ceramic structural member according to claim 7, wherein
the ceramic layer has a porosity falling within a range from 50 to 70%.

9. The gas sensor including the ceramic structural member according to claim 1,
wherein the ceramic layer is an air-pass layer configured to pass gas though the air-pass layer;
wherein the air-pass layer is provided between the base body and a measuring portion of the gas sensor; and
wherein the measuring portion includes a solid electrolyte layer formed on a surface of the base body and electrode layers formed to sandwich the solid electrolyte layer between the electrode layers.

10. The gas sensor including the ceramic structural member according to claim 1, wherein
the gas sensor is provided upstream or downstream of a catalyst provided for purifying exhaust gas of an internal combustion engine.

11. A gas sensor comprising:
a sensing element configured to sense a gas component;
a holder formed with an insertion hole, the sensing element being fitted into the insertion hole by insertion;
a seal portion sealing between the holder and an outer circumference of the sensing element by filling a sealant storage space with a compressed sealant, the sealant storage space being located on an outer circumference of the insertion hole of the holder; and
a porous ceramic layer provided in at least a portion of a surface of the sensing element, the portion receiving a load caused by the filling of the sealant, the porous ceramic layer being formed of an admixture of a plurality of ceramic materials having at least one of grain diameters different from each other and specific surface areas different from each other.

12. The gas sensor according to claim 11, wherein
the admixture includes one ceramic material having a grain diameter falling within a range from 0.05 to 0.5 μm which is indicated when an accumulation in grain size distribution is equal to 50%, and another ceramic material having a grain diameter falling within a range from 0.8 to 5.0 μm which is indicated when the accumulation in grain size distribution is equal to 50%.

13. The gas sensor according to claim 11, wherein
the admixture includes one ceramic material having a grain diameter falling within a range from 0.1 to 0.3 μm which is indicated when an accumulation in grain size distribution is equal to 50%, and another ceramic material having a grain diameter falling within a range from 1.0 to 2.0 g m which is indicated when the accumulation in grain size distribution is equal to 50%.

14. The gas sensor according to claim 11, wherein
the admixture includes one ceramic material having a specific surface area falling within a range from 8 to 20 m²/g, and another ceramic material having a specific surface area falling within a range from 0.5 to 2.0 m²/g.

15. The gas sensor according to claim 11, wherein
the admixture includes one ceramic material having a specific surface area falling within a range from 12 to 15 m²/g, and another ceramic material having a specific surface area falling within a range from 0.9 to 1.3 m²/g.

16. The gas sensor according to claim 12, wherein
the admixture includes the one ceramic material at a rate ranging from 90 to 99 wt %, and the another ceramic material at a rate ranging from 1 to 10 wt %.

17. The gas sensor according to claim 11, wherein
the admixture is added to a pore forming agent accounting for a rate ranging from 45 to 50 wt % of a total of the admixture and the pore forming agent; and
the admixture is sintered to form the porous ceramic layer.

18. The gas sensor according to claim 17, wherein
the porous ceramic layer has a porosity falling within a range from 50 to 70%.

19. The gas sensor according to claim 11, wherein
a thickness of the porous ceramic layer falls within a range from 5 to 100 μm.

20. The gas sensor according to claim 11, wherein
the gas sensor is provided upstream or downstream of a catalyst provided for purifying exhaust gas of an internal combustion engine.
